(19) United States
(12) Patent Application Publication
(10) Pub. No.: US 2017/0041160 A1
(43) Pub. Date: Feb. 9, 2017

(54) MULTIFUNCTIONAL WIRELESS NETWORK CONTROL

(71) Applicant: General Electric Company, Schenectady, NY (US)

(72) Inventors: Haitian Hu, Louisville, KY (US); Richard DeVos, Goshen, KY (US); John P. Ouseph, Prospect, KY (US)

(21) Appl. No.: 14/820,821

(22) Filed: Aug. 7, 2015

(51) Int. Cl. H04L 12/28; H04L 29/08; H04W 76/02; H04L 12/24

(52) U.S. Cl. CPC H04L 12/2816; H04L 41/0803; H04L 67/104; H04W 76/02; H04W 84/18

(57) ABSTRACT

Systems and methods of controlling one or more aspects of a wireless network are provided. In particular, a home appliance, such as a refrigeration appliance can be configured to detect and join a home area network. The home appliance can then be configured to facilitate the connection of at least one network device to the home area network. The home appliance can further be configured to receive data from the router, amplify the data, and retransmit the data, thereby extending the range of the home area network.

### FIELD OF THE INVENTION

The present subject matter relates to appliance devices, and more particularly to a multi-functional network controller associated with an appliance device.

### BACKGROUND OF THE INVENTION

Wireless based home automation has become increasingly popular in recent years. For instance, such automation has been driven by the Internet of Things and big data technology. In this regard, home area networks may be implemented using wireless technologies, such as for instance, WiFi, Bluetooth, ZigBee, cellular technologies, and/or various other suitable technologies. Home area networks may facilitate communication between one or more network devices such as home appliances, personal computers, laptop computers, smartphones, tablets, wearable devices, etc. Home area networks can further provide a connection with various other networks, such as the Internet.

However, such home area networks may be difficult to implement and/or manage. For instance, it can be a difficult process to configure a network device to join a home area network. Further, the typical communication range of a home area network is limited in a household, which can result in poor reception and poor internet reliability. Thus, a need exists for improved home area network control and/or regulation.

### BRIEF DESCRIPTION OF THE INVENTION

Aspects and advantages of the invention will be set forth in part in the following description, or may be obvious from the description, or may be learned through practice of the invention.

One example aspect of the present disclosure is directed to a system for controlling one or more aspects of a network. The system includes one or more network devices configured to communicate over a network. The system further includes a home appliance configured to communicate with the one or more network devices to facilitate a connection of at least one of the one or more network devices to the network. The home appliance is further configured to receive one or more signals from a router associated with the network and retransmit the one or more signals, thereby increasing a range of the network. The home appliance has a primary functionality that is different from facilitating network communications.

Another example aspect of the present disclosure is directed to a refrigeration appliance configured to control one or more aspects of a home area network. The refrigeration appliance includes one or more processors and one or more memory devices. The one or more memory devices store computer-readable instructions that when executed by the one or more processors cause the one or more processors to perform operations. The operations include receiving one or more signals from a router indicative of a presence of a home area network. The operations further include, responsive to receiving the one or more signals, joining the home area network. The operations further include controlling one or more aspects of the home area network. Controlling the one or more aspects of the home area network includes communicating with one or more network devices to facilitate a connection of at least one of the one or more network devices to the home area network. Controlling the one or more aspects of the home area network further includes receiving data from the router and retransmitting the data, thereby increasing a range of the home area network.

Yet another aspect of the present disclosure is directed to a method of controlling one or more aspects of a home area network. The method includes receiving, by a refrigeration appliance, one or more signals indicative of a presence of a home area network. The method further includes, responsive to receiving the one or more signals, joining, by the refrigeration appliance, the home area network. The method further includes controlling, by the refrigeration appliance, one or more aspects of the home area network by communicating with one or more network devices to facilitate a connection of at least one of the one or more network devices to the home area network, and receiving data from the router and retransmitting the data, thereby increasing a range of the home area network.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts a system for controlling one or more aspects of a wireless network according to example embodiments of the present disclosure;

FIG. 2 depicts a system for communicating within a network using an ad-hoc mode of communication according to example embodiments of the present disclosure;

FIG. 3 depicts a system for communicating within a network using an infrastructure mode of communication according to example embodiments of the present disclosure; and

FIG. 4 depicts a flow diagram of an example method of controlling one or more aspects of a network according to example embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Example embodiments of the present disclosure are directed to a home appliance configured to act as a multifunctional network control device. In particular, the multifunctional network control device can function as a network router, network extender, and/or network controller. Such multi-functional network control functionality can be implemented in a home appliance having a primary functionality that is different from facilitating network communications. For instance, such home appliance can be a refrigeration appliance or other suitable appliance. Example aspects of the present disclosure can be implemented using software and/or hardware techniques.

In example embodiments, a home appliance can be configured to facilitate the connection of one or more electronic devices to a network, such as a home area network. In particular, the home appliance can be configured to detect the presence of a home area network, and to join the network. For instance, the home appliance can be configured to communicate (e.g. using a wired or wireless connection) with a router associated with a home area network to facilitate joining the home area network. Once the home appliance has joined the network, the home appliance can be configured to control one or more aspects of the router. In this manner, the home appliance can be configured to facilitate connection of one or more electronic devices to the home area network via communication with the router.

In further example embodiments, the home appliance can further be configured as a wireless network extender. In particular, the home appliance can be configured to extend the range in which signals from the router may be detected. For instance, when the home appliance receives one or more wireless signals from the router and/or a wireless access point associated with the home area network, the home appliance can be configured to amplify the received signals, and to retransmit the amplified signals. In this manner, one or more electronic devices that are unable to receive a suitable signal from the wireless router and/or access point (e.g. due to the distance and/or any obstructions between the devices) may be able to receive the extended signal when retransmitted by the home appliance.

In still further example embodiments, the home appliance can be configured as a subnetwork switch for the home area network. In particular, the home area network can be segmented into one or more subnetworks. Each subnetwork can be used for various different applications. Each subnetwork may have different bandwidths and/or different capabilities. In this manner, traffic between devices comprising one subnetwork associated with the home area network may not affect the available bandwidth of a different subnetwork associated with the home area network. In such embodiments, the home appliance can be configured as a switch to forward received data to a destination node in each subnetwork.

The home appliance can be configured to receive one or more inputs from a user to facilitate the network control functionalities as described herein. In particular, a user may interact with a user interface (UI) screen located on the home appliance. In this manner, the user may, through interaction with the UI screen, control one or more aspects of a home area network. For instance, the user may provide one or more inputs indicative of a request for the home appliance to connect to and/or manage a home network router, connect to a wireless hotspot, and/or become a wireless hub (or access point) for one or more electronic devices to join.

Example aspects of the present disclosure can be implemented using various suitable hardware and/or software techniques. For instance, aspects of the present disclosure may be implemented by using software techniques in conjunction with existing electronic components associated with a home appliance. As another example, various hardware modifications may be added to a home appliance to implement aspects of the present disclosure. In particular, one or more wireless extender boards may be used in conjunction with a home appliance. Such extender boards may be integrated into one or more existing control devices (e.g. control board) associated with the home appliance, or may be separate and distinct components, external to the existing control devices. In further embodiments, such hardware and/or software implementations may be implemented external to the home appliance, for instance, in conjunction with one or more external devices.

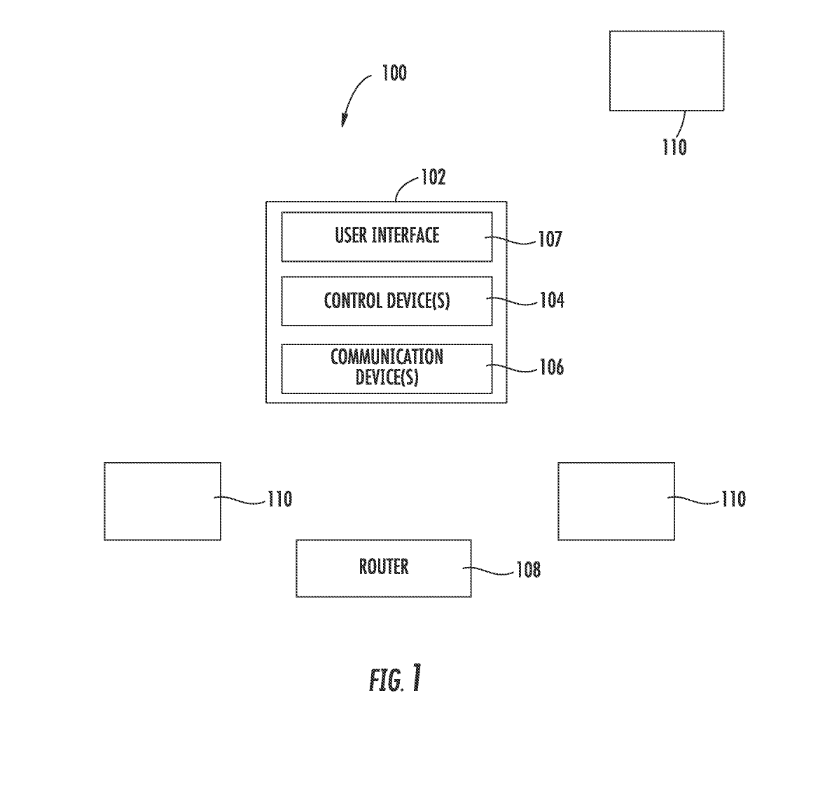

Turning now to the figures, FIG. 1 depicts an example system 100 for providing one or more aspects of network control using a home appliance according to example embodiments of the present disclosure. In particular, system 100 can include a home appliance 102. In example embodiments, home appliance 102 may be an appliance having a primary functionality that is different than facilitating network communications, such as a refrigerator, an oven, a range, a washer, a dryer, a dishwasher, or various other suitable home appliances. Home appliance 102 can include one or more control devices 104. Control device(s) 104 may be configured to control one or more aspects of a home area network. For instance, as described above, control device(s) 104 may be configured to act as a network controller, a network router, and/or a network (or subnetwork) switch.

In example embodiments, control device(s) 104 can include any number of control devices. In one implementation, for example, control device(s) 104 can include one or more processor(s) and associated memory device(s) configured to perform a variety of computer-implemented functions and/or instructions (e.g. performing the methods, steps, calculations and the like and storing relevant data as disclosed herein). The instructions when executed by the processor can cause the processor to perform operations, including providing control commands to various aspects of system 100.

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. The processor is also configured to compute advanced control algorithms and communicate to a variety of Ethernet or serial-based protocols (Modbus, OPC, CAN, etc.). Additionally, the memory device(s) may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) may generally be configured to store suitable computer-readable instructions that, when implemented by the processor(s), configure control device(s) 104 to perform the various functions as described herein.

Home appliance 102 can further include one or more communication devices 106. Communication device(s) 106 may be configured to facilitate wired and/or wireless communication between home appliance 102 and various other devices, such as a router 108 and/or one or more network devices 110 via a home area network. Router 108 can be configured to provide a connection between the home area network and another network, such as for instance, the internet. It will be appreciated that router 108 may be integrated in home appliance 102 or may be a separate and distinct device external to home appliance 102. It will be further appreciated that the home area network may further include any number of suitable wireless and/or wired access points configured to allow a network devices 110 to connect to the home area network.

Home appliance 102 can further include a user interface 107. User interface 107 may be located on an external portion of home appliance 102, such that a user may access user interface 107. For instance, in embodiments wherein home appliance 102 is a refrigeration appliance, user interface 107 may be located on an external door of the refrigeration appliance. User interface 107 may provide for display data associated with one or more aspects of a home area network. For instance, such data may include data related to one or more devices connected to the network, one or more settings associated with the network, one or more capabilities of the network, etc. User interface 107 may be further configured to perform one or more actions responsive to an input from a user. For instance, a user may be able to request that a network device join the network through interaction with user interface 107.

Network devices 110 may include any electronic device capable of communicating with one or more other devices over a network. For instance, network devices 110 may include one or more home appliances, laptop computers, smartphones, tablets, personal computers, wearable devices, and/or various other suitable devices.

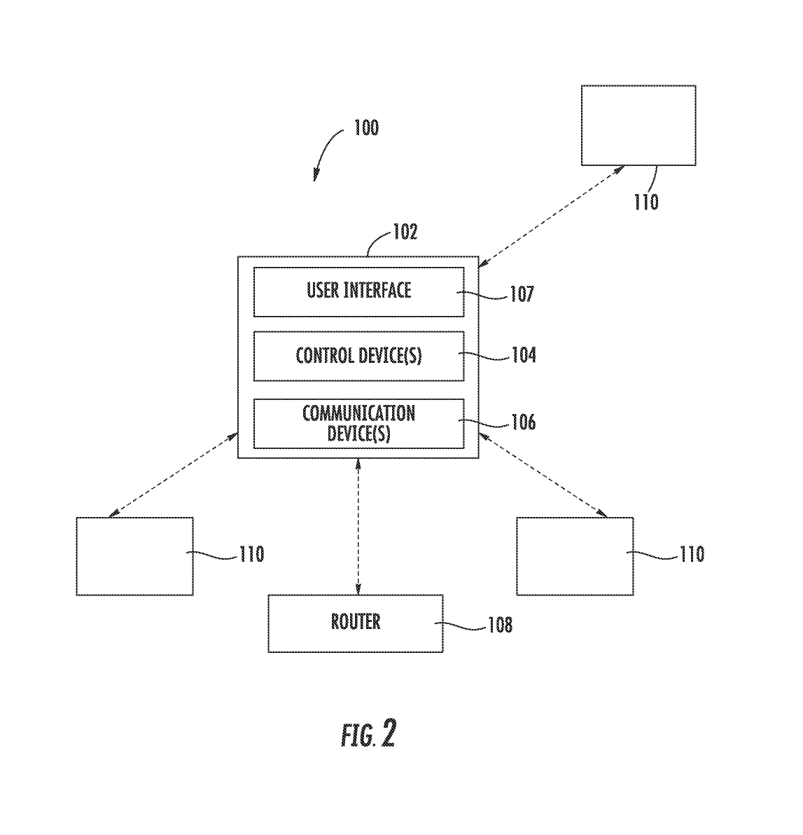

In example embodiments, home appliance 102 may be configured to operate in a peer-to-peer (e.g. ad-hoc) communication mode. For instance, FIG. 2 depicts an example system 100 for implementing an ad-hoc communication mode according to example embodiments of the present disclosure. As depicted in FIG. 2, while in ad-hoc mode, home appliance 102 may be configured to communicate directly with network devices 110 in a peer-to-peer manner. In this manner, a wireless access point (e.g. router 108) may not be needed to facilitate communication between home appliance 102 and network devices 110.

In such embodiments, during ad-hoc mode, home appliance 102 may act as a network controller. For instance, home appliance 102 may be configured to control one or more aspects of the home area network through direct communication with network devices 110. In particular, home appliance 102 may be configured to act as a wireless (or wired) hub, for network devices 110 to join, such that network devices 110 may be able to communicate with each other via home appliance 102. In this manner, home appliance 102 may be configured to forward data received from one or more network devices to one or more other network devices.

As another example, during ad-hoc mode, home appliance 102 may be configured to connect one or more network devices 110 to router 108, such that the one or more network devices may join a home area network. For instance, network devices 110 may provide one or more identifying signals (e.g. MAC address) to home appliance 102. Home appliance 102 may then communicate the identifying signals to router 108 to facilitate connection of the network devices to the router.

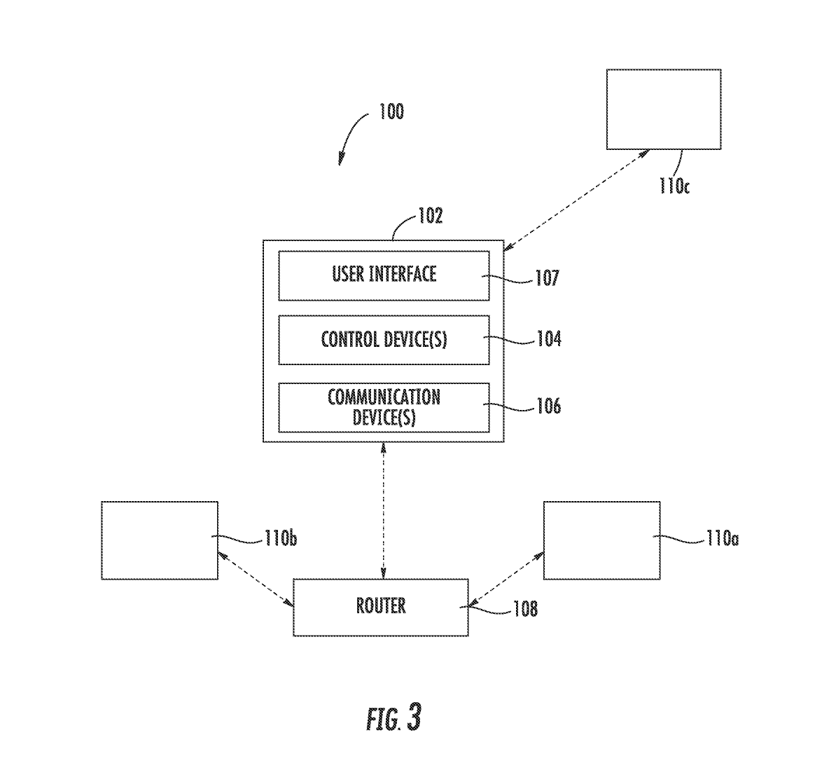

Home appliance 102 may be further configured to operate in an infrastructure mode. For instance, FIG. 3 depicts an example system 100 for implementing an infrastructure mode according to example embodiments of the present disclosure. In such embodiments, home appliance 102 may be configured to communicate with network devices 110 via a wireless access point (e.g. router 108 or other access point).

As indicated above, in example embodiments, home appliance 102 may be further configured to act as a wireless range extender. In particular, home appliance 102 may be configured to receive one or more signals from router 108, amplify such received signals, and retransmit the amplified signals. In this regard, such signals may be able to be received by one or more electronic devices that would otherwise not be able to receive signals with suitable strength from router 108, for instance due to the distance between the electronic devices and the router and/or obstructions between the electronic devices and the router that may obscure such signals.

For instance, FIG. 3 depicts network devices 110a, 110b, and 110c. Network devices 110a and 110b are located proximate router 108 such that they may receive wireless signals from router 108 with sufficient strength for communication. However, network device 110c may be located far enough away from router 108 such that any signals received by network device 110c from router 108 are insufficient for communication. In this regard, home appliance 102 may retransmit one or more signals received from router 108 such that the signals may be received by network device 110c. Such received signals from home appliance 102 may be of sufficient strength for communication.

While operating in infrastructure mode, home appliance 102 may be further configured to act as a network switch. In this manner, home appliance 102 may be configured to communicate with router 108 (or other access point) to forward data to a destination network device. For instance, data sent over a home area network may be sent to home appliance 102 via an access point (e.g. router 108). Home appliance 102 may then determine a destination for the data in the home area network, and forward the data to the destination.

In example embodiments, home appliance 102 may be configured to create one or more subnetworks within the home area network. For instance, home appliance 102 may be configured to divide the network into one or more subnetworks having different capabilities and/or bandwidths. Such subnetworks may be used for different applications within the home area network. In this manner, home appliance 102 may act as a subnetwork switch configured to forward data to one or more destination devices within each subnetwork.

Home appliance 102 may be configured to communicate with router 108 and/or network devices 110 using various suitable techniques. For instance, the communication may be performed using wired and/or wireless connections. When wireless connections are used, home appliance 102 may be configured to communicate using any suitable number of radios. For instance, home appliance 102 may use two radios to communicate by sending data by one radio and receiving data by another. As another example, home appliance 102 may use a single radio to communicate. In such embodiments, data can be sent and received by the same radio. Such implementations may be used, for instance, when less intensive communication is required. For instance, communication between home appliances may be less intensive than communication used for online gaming. In this manner, 2 radios may be used for more intensive communication and 1 radio may be used for less intensive communication.

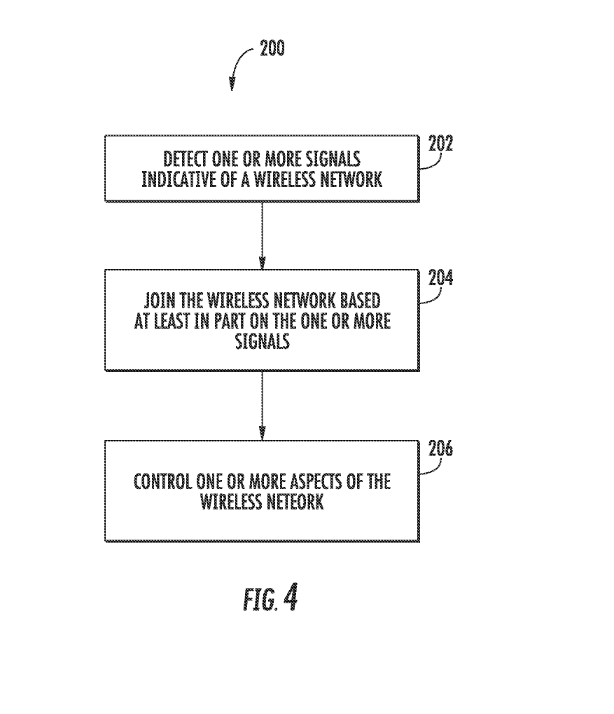

FIG. 4 depicts a flow diagram of an example method (200) of controlling one or more aspects of a home area network according to example embodiments of the present disclosure. FIG. 4 depicts steps performed in a particular order for purposes of illustration and discussion. Those of ordinary skill in the art, using the disclosures provided herein, will understand that the various steps of any of the methods disclosed herein can be adapted, modified, expanded, omitted, or rearranged in various ways without deviating from the scope of the present disclosure.

At (202), method (200) can include detecting one or more signals indicative of a presence of a wireless network. For instance, a home appliance may be configured to detect a home area network as implemented by a router, such as router 108.

At (204), method (200) can include joining the detected home area network. In example embodiments, the home appliance may be configured to join the home area network automatically based on the one or more received signals. In alternative embodiments, the home appliance may be configured to join the network in conjunction with assistance from a user and/or a user device (e.g. laptop, smartphone, tablet, personal computer, wearable device, etc.). For instance, the home appliance may be configured to connect using a simultaneous smart button connection technique (e.g. user presses a button on the home appliance and on the router).

At (206), method (200) can include controlling one or more aspects of the home area network. For instance, as described above, the home appliance may be configured to facilitate the connection of one or more network devices to the router. In this manner, the home appliance may be configured to operate in a peer-to-peer mode, and/or an infrastructure mode, as described above. In further example embodiments, the home appliance may be configured to act as a wireless network extender to extend a broadcast range of one or more signals broadcast by a router associated with the network.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for controlling one or more aspects of a network, the system comprising:
one or more network devices configured to communicate over a network; and
a home appliance configured to communicate with the one or more network devices to facilitate a connection of at least one of the one or more network devices to the network, the home appliance further configured to receive one or more signals from a router associated with the network and retransmit the one or more signals, thereby increasing a range of the network, wherein the home appliance has a primary functionality that is different from facilitating network communications.

2. The system of claim 1, wherein the home appliance is further configured to implement an ad-hoc mode of communication, whereby the home appliance communicates directly with the one or more network devices through peer-to-peer communication.

3. They system of claim 1, wherein the home appliance is further configured to implement an infrastructure mode of communication, whereby the home appliance communicates with the one or more network devices via an access point associated with the network.

4. The system of claim 3, wherein the home appliance is further configured to divide the network into one or more subnetworks, and to facilitate the connection of at least one of the one or more network devices to at least one subnetwork.

5. The system of claim 4, wherein the home appliance is further configured to operate as a subnetwork switch by forwarding received data packets to an intended destination within each of the subnetworks.

6. The system of claim 1, wherein the home appliance is further configured to receive one or more signals indicative of the presence of the network and, responsive to receiving the one or more signals, to join the network.

7. The system of claim 6, wherein the home appliance is configured to automatically join the network.

8. The system of claim 6, wherein the home appliance is configured to join the network responsive to a user interaction with a router associated with the network.

9. The system of claim 6, wherein the home appliance is configured to join the network responsive to a user interaction with a user device associated with the network.

10. The system of claim 1, wherein the home appliance is configured to communicate with the one or more network devices using two radios, wherein the home appliance sends data by a first radio, and receives data by a second radio.

11. The system of claim 1, wherein the home appliance is configured to communicate with the one or more network devices using a single radio, wherein the home appliance sends and receives data by the single radio.

12. The system of claim 1, wherein the home appliance is a refrigeration appliance, an oven, a range, a washer, a dryer, or a dishwasher.

13. A refrigeration appliance configured to control one or more aspects of a home area network, the refrigeration appliance having a primary functionality that is different from facilitating network communications, the refrigeration appliance comprising:
one or more processors; and
one or more memory devices, the one or more memory devices storing computer-readable instructions that when executed by the one or more processors cause the one or more processors to perform operations, the operations comprising:
receiving one or more signals from a router indicative of a presence of a home area network;
responsive to receiving the one or more signals, joining the home area network; and
controlling one or more aspects of the home area network;
wherein controlling the one or more aspects of the home area network comprises communicating with one or more network devices to facilitate a connection of at least one of the one or more network devices to the home area network, and wherein controlling the one or more aspects of the home area network further comprises receiving data from the router and retransmitting the data, thereby increasing a range of the home area network.

14. The home appliance of claim 13, wherein controlling the one or more aspects of the home area network comprises implementing an ad-hoc communication mode, wherein the home appliance is configured to communicate directly with the one or more network devices through peer-to-peer communication.

15. The home appliance of claim 13, wherein controlling the one or more aspects of the home area network comprises implementing an infrastructure communication mode, wherein the home appliance is configured to communicate with the one or more network devices via an access point associated with the home area network.

16. The home appliance of claim 15, wherein controlling the one or more aspects of the home area network further comprises dividing the home area network into one or more subnetworks, and facilitating the connection of at least one of the one or more network devices to at least one subnetwork.

17. A method of controlling one or more aspects of a home area network, the method comprising:
receiving, by a refrigeration appliance, one or more signals indicative of a presence of a home area network;
responsive to receiving the one or more signals, joining, by the refrigeration appliance, the home area network; and
controlling, by the refrigeration appliance, one or more aspects of the home area network by communicating with one or more network devices to facilitate a connection of at least one of the one or more network devices to the home area network, and receiving data from the router and retransmitting the data, thereby increasing a range of the home area network;
wherein the refrigeration appliance has a primary functionality that is different from facilitating network communications.

18. The method of claim 17, wherein controlling the one or more aspects of the home area network further comprises implementing an ad-hoc communication mode, wherein the home appliance is configured to communicate directly with the one or more network devices through peer-to-peer communication.

19. The method of claim 17, wherein controlling the one or more aspects of the home area network further comprises implementing an infrastructure communication mode, wherein the home appliance is configured to communicate with the one or more network devices via an access point associated with the home area network.

20. The method of claim 19, wherein controlling the one or more aspects of the home area network further comprises dividing the home area network into one or more subnetworks, and facilitating the connection of at least one of the one or more network devices to at least one subnetwork.
